(19) United States
(12) Patent Application Publication
(10) Pub. No.: US 2023/0136946 A1
(43) Pub. Date: May 4, 2023

(54) STORE OUTLET

(71) Applicant: ROTZINGER AG, KAISERAUGST (CH)

(72) Inventor: Kurt Philipp, Grenzach-Wyhlen (DE)

(73) Assignee: ROTZINGER AG, KAISERAUGST (CH)

(21) Appl. No.: 17/788,108

(22) PCT Filed: Dec. 23, 2020
(86) PCT No.: PCT/EP2020/087738

§ 371 Date: Dec. 9, 2022

(30) Foreign Application Priority Data
Dec. 23, 2019 (CH) 01698/19

(51) Int. Cl. B65G 47/04; B65G 47/64; B65G 37/00

(52) U.S. Cl. CPC B65G 47/04; B65G 37/005; B65G 47/647

(57) ABSTRACT

One or more discharge belts (10) receiving product lines from the storage, are arranged one above the other at the outlet of the storage for products from an interim storage (1) with product carriers (2, 3) on a plurality of planes in the lateral direction. The discharge belts transfer the product lines to a plurality of downstream receiving belts (14) arranged one above the other. The inlet deflectors (15) of the receiving belts are jointly height-adjustable.

### CROSS REFERENCE TO RELATED APPLICATION

This application claims priority to PCT Application, having application serial no. PCT/EP2020/087738 that was filed on Dec. 23, 2020, the entirety of which is incorporated by reference herein.

### TECHNICAL FIELD

The invention relates to a storage outlet on an interim storage device according to the generic concept of claim 1.

### BACKGROUND

Interim storage units are used to decouple processes and increase efficiency in production lines, for example in the food industry. This involves taking the piece goods produced in lines from a furnace or casting plant with a wide main belt and feeding them to the packaging plant in a short path. These are typically biscuits, chocolate bars, chocolate bars or the like.

Depending on the production capacity, several parallel packaging lines may be necessary in order to package the produced quantity with the lowest possible reject rate. In this case, a packaging line frequently comprises a plurality of packaging machines connected in series, such as, for example, a tubular packaging machine in the first position, a multi packing machine in the second position, a cartoner in the third position and, lastly, a palletizer. If a machine stops in this line due to a fault, then the whole line fails.

In order to avoid overflow during constant production, either an additional so-called standby packaging line has to step in or a buffer storage buffers the excess products so that an overflow of products (rejects) can be avoided. These interim storages operate on the first-in-first-out principle, which is usually used in the food industry when handling unpackaged piece goods.

When designing the overall line, the installed packaging capacity must be greater than the production capacity. In general, this overhang is at least 20%. If the filling level of the interim storage rises as a result of stops in the packaging, the packaging machines can be charged with product from the storage at a higher speed as soon as they are available again. As a rule, the degree of filling the interim storage is connected to the packaging speed. In this way, an imminent overfilling of the reservoir can be counteracted at an early stage.

The interim storage shown in this description consists of a pair of endless chains which are guided in vertical loops over supported sprocket deflectors. The chains are equipped with product carrier pods all around. The chain loops can be lengthened or shortened via vertically displaceable chain deflections. The empty product carrier pods are located below the inlet and outlet planes and below the displaceable chain deflectors, the product carrier pods filled with product lines are located above the inlet and outlet planes and the product carrier pods filled with product lines are located above the displaceable chain deflector.

The interim storage takes over the product lines arriving in lines in the inlet frontally from a main belt onto the product carrier pods which are rotatably suspended on the endless chain pair. The product carrier pods consist of vertically spaced product carrier trays which can receive the product lines. In this process, the product lines are fed over the main belt at a minimum speed for the product lines to slide safely onto the trays as a result of the existing kinetic energy. A separate insertion device is not required. Interim storages of this type are known, for example, from...

The interim storage has a servo-controlled chain drive at the inlet, which is synchronized with the incoming product flow. This drive accelerates or decelerates the chains in such a way that an empty product carrier tray is always provided in good time on the inlet plane. The filled product carrier trays are moved vertically upwards and transferred into the upper region of the interim storage filled with product. At the same time, empty product carrier pods are moved out of the lower empty region of the interim storage in the direction of the inlet plane.

According to the prior art, up to two packaging lines can be fed with product lines via narrow conveyor belts at the outlet of the interim storage in the lateral direction on up to two push-out planes. For this purpose, a servo-controlled ejector for each packaging line is arranged in the outlet region of the interim storage at the level of the respective ejection planes. The pusher pushes the product lines through the pod for them to come to rest centrally on the respective discharge belt. The product lines are then conveyed on both push-out planes in a speed-synchronous manner in the lateral direction to the packaging lines. As soon as the discharge belts are free, they are stopped so that the pushers can push the next product lines out of the storage. The ejection creates a gap to the leading product series. The trailing product line is closed at a higher speed by means of belts connected downstream of the discharge belt, so that the packaging lines always receive a continuous, gap-free product stream at the takeover point. When the lower push-out plane is stopped, the chain drive must position the chain with the product carrier pods in the opposite direction upwards on the upper, still active push-out plane in the outlet of the storage, so that the product line, which was actually provided for the lower push-out plane, can then be fed via the upper push-out plane to the connected packaging line. Otherwise, this line would be lost, since it would otherwise be discharged in the lower empty return region of the Storage.

The servo-controlled chain drive in the outlet of the storage positions the chain cyclically downwards, so that a product carrier tray filled with product is always available on the respective push-out plane in a timely manner. When both ejection planes are active, the product carrier pods are always moved vertically downwards by two product carrier trays in cycles in order to always have two new product lines for both push-out planes ready in a timely manner. If only one push-out plane is active, then the product carrier pods are moved downwards in cycles by one product carrier tray.

The fact that, according to the present state of the art, no more than two packaging lines can be loaded directly with product lines is due to the fact that the packaging lines connected downstream of the push-out planes start and stop quite chaotically and, as a result, there are too many load cases and operating states for the control of the gondola chains which can massively reduce the efficiency of the storage outlet or even lead to a blockage.

A further disadvantage of the known devices is that the two packaging lines are forcibly synchronized, since only the same quantities of product for both packaging lines can be pushed out of the same pod chain in the storage outlet. In reality, therefore, the two packaging lines cannot be operated at different speeds. In addition, the two packaging lines have a negative influence on each other. If one of the two packaging lines stops, there is a gap in the product flow for the other packaging machine, which is equivalent to a loss of efficiency, or that after a stop, the restart must be delayed and this can also result in a loss of efficiency.

It is an object of the invention to solve this problem in such a way that more than two packaging lines can be operated.

### SUMMARY

According to the invention, this object is achieved by a storage outlet for products from an interim storage with product carriers on a plurality of levels in the lateral direction, characterized in that one or more discharge belts are arranged one above the other, which receive product lines from the storage and transfer them to a plurality of downstream receiving belts which are arranged one above the other and whose inlet deflectors are jointly height-adjustable.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are, therefore, not to be considered limiting of its scope, for the invention may admit to other equally effective embodiments. It is emphasized that the figures are not necessarily to scale and certain features and certain views of the figures can be shown exaggerated in scale or in schematic for clarity and/or conciseness.

FIG. 1 depicts an interim storage that essentially corresponds to the state of the art,

FIG. 2 depicts an overall view of an installation with an interim storage and product supply to three packaging lines,

FIG. 3 depicts an enlarged representation of the outlet-side part of the interim storage and of the product discharge on three levels,

FIG. 4 depicts different variants of the product discharge on three levels,

FIG. 5 depicts an overall view of an installation with an interim storage and product supply to four packaging lines,

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure can repeat reference numerals and/or letters in the various embodiments and across the figures provided herein. This repetition is for the purpose of simplicity and clarity and does not in itself dictate a relationship between the various embodiments and/or configurations. Moreover, the exemplary embodiments presented below can be combined in any combination of ways, i.e., any element from one exemplary embodiment can be used in any other exemplary embodiment, without departing from the scope of the disclosure.

Additionally, certain terms are used throughout the following description and claims to refer to particular components. As one skilled in the art will appreciate, various entities can refer to the same component by different names, and as such, the naming convention for the elements described herein is not intended to limit the scope of the invention, unless otherwise specifically defined herein. Further, the naming convention used herein is not intended to distinguish between components that differ in name but not function.

Furthermore, in the following discussion and in the claims, the terms “including” and “comprising” are used in an open-ended fashion, and thus should be interpreted to mean “including, but not limited to.” The phrase “consisting essentially of” means that the described/claimed composition does not include any other components that will materially alter its properties by any more than 5% of that property, and in any case does not include any other component to a level greater than 3 mass%.

Unless otherwise indicated, all numerical values are “about” or “approximately” the indicated value, meaning the values take into account experimental error, machine tolerances and other variations that would be expected by a person having ordinary skill in the art. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

The term “or” is intended to encompass both exclusive and inclusive cases, i.e., “A or B” is intended to be synonymous with “at least one of A and B,” unless otherwise expressly specified herein.

The indefinite articles “a” and “an” refer to both singular forms (i.e., “one”) and plural referents (i.e., one or more) unless the context clearly dictates otherwise. For example, embodiments using “an olefin” include embodiments where one, two, or more olefins are used, unless specified to the contrary or the context clearly indicates that only one olefin is used.

Each of the appended claims defines a separate invention, which for infringement purposes is recognized as including equivalents to the various elements or limitations specified in the claims. Depending on the context, all references to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

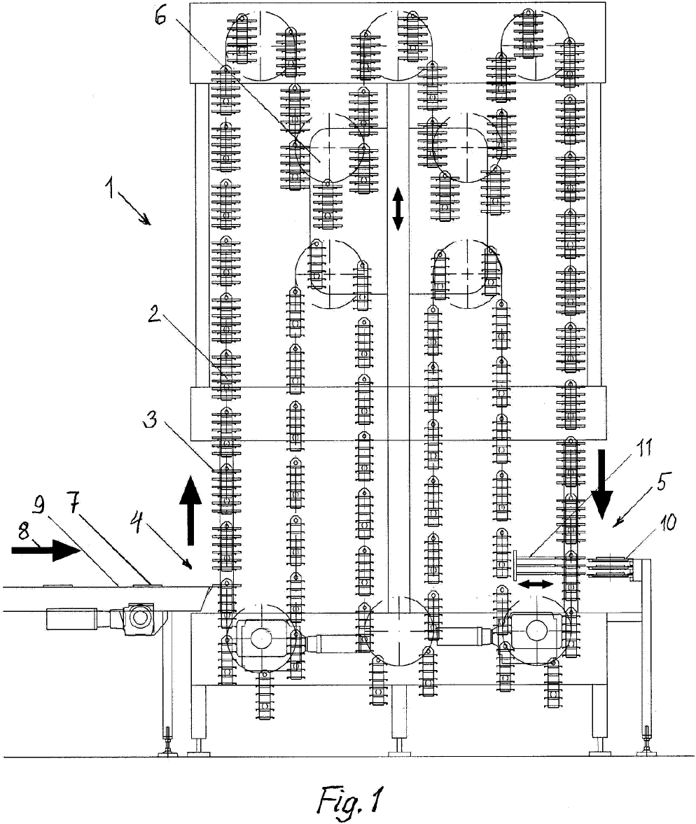

The interim storage 1 shown in FIG. 1 corresponds essentially to the known chain storages with pods hanging on parallel circulating endless chains (not shown), which pods 2 are provided with a number of product carrier trays 3 arranged one above the other. In a predominantly upper region, the pods loaded with products run from the product inlet 4 to the product outlet 5, while in the predominantly lower region the empty gondolas are returned to the product inlet. The ratio of the upper (filled) region to the lower (empty) region can be varied by means of vertically adjustable deflection rollers 6.

At the product inlet, product lines 7 arrive on a wide main conveyor belt 9 in the main conveying direction indicated by the arrow 8 and, as described at the beginning, are transferred to the trays of the product carrier pods and subsequently conveyed to the product outlet.

Provided at the product outlet 5 are a plurality of discharge belts 10 which are arranged one above the other and run transversely with respect to the main conveying direction. In the case shown here, there are three discharge belts which can take over product lines from the trays located on the same plane. The product lines are transferred by a pusher arranged on the other side of the pods and having push-out strips 11 which are arranged one above the other and correspond to the number of discharge belts and which push the product lines through the respective pod onto the corresponding discharge belts. Up to this point, everything corresponds to the arrangements known from the prior art, with the exception of the discharge device on three levels, as will be explained in more detail below.

The discharge belts define push-out planes whose vertical distance corresponds to the vertical distance between two product carrier trays or an integral multiple thereof. The number of push-out planes arranged one above the other is determined from the total output of the packaging lines which are to be fed with product lines from the outlet of the interim storage.

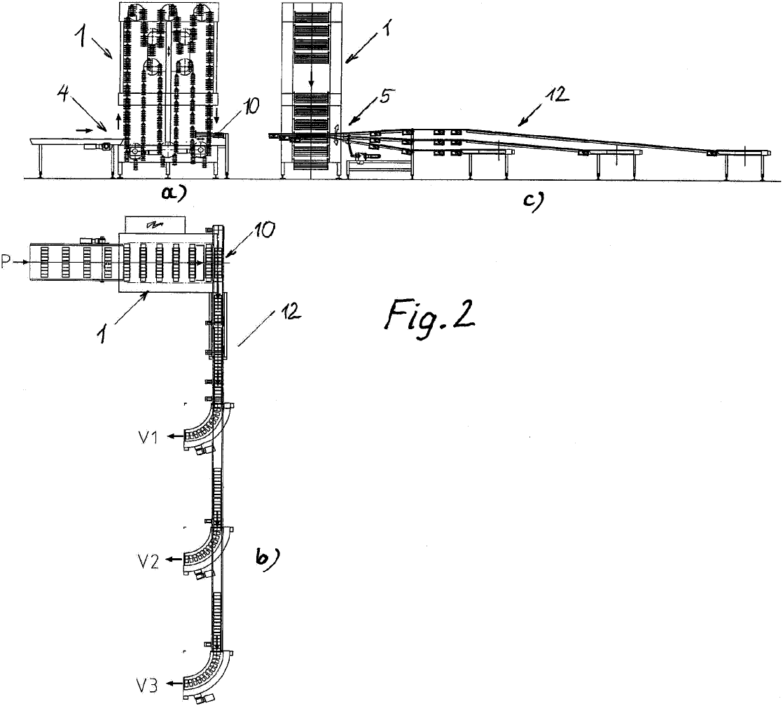

FIG. 2 shows an overall system with an interim storage 1, product inlet and product outlet, as well as the further lateral conveying sections from the discharge belts 10 to the packaging lines V1-V3. FIG. 2a corresponds to FIG. 1. FIG. 2b is a top view of the system and shows the course of the further conveying sections 12 to the packaging lines. FIG. 2c is a front view of the system and shows the discharge belts with their drives and a side view of the further conveying sections arranged downstream of the discharge belts.

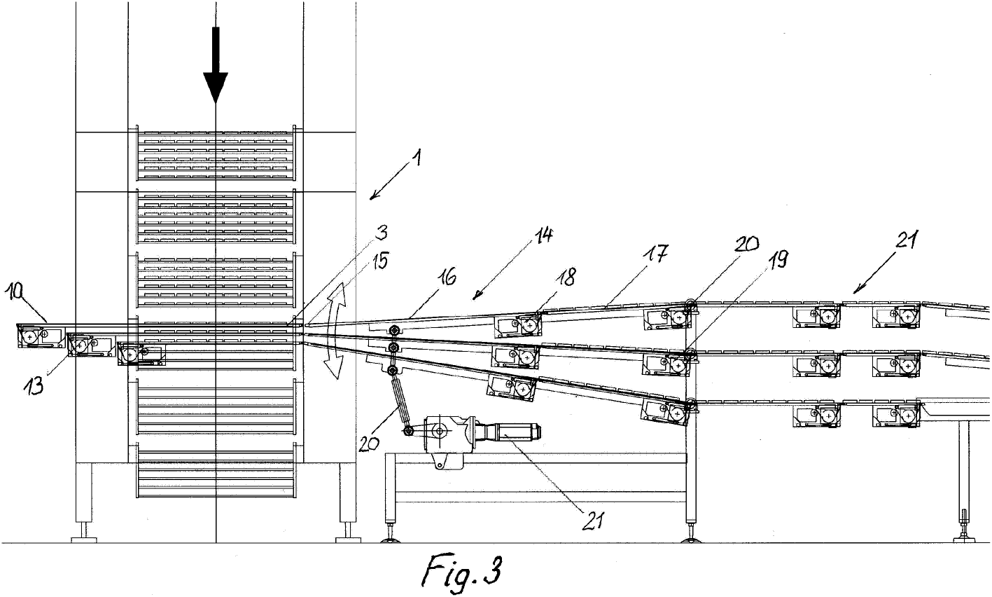

The discharge region comprising the discharge belts and the subsequent receiving conveyor belts is shown in detail in FIG. 3. Three discharge belts 10 with their individual drive devices 13 run along the longitudinal sides of three product carrier trays positioned one above the other in the interim storage 1, that is to say transversely with respect to the main conveying direction.

In the embodiment shown, the three discharge belts 10 are likewise followed by three receiving belts 14 arranged one above the other, the inlet-side belt deflectors 15 of which are located at the respective height of the discharge belts in order to take over the products from the discharge belts. The length of these belts is greater than or at least equal to the length of the product lines, so that complete product lines can be placed on these belts.

In the embodiment shown in FIG. 3, each receiving belt 14 consists of two successive belts 16, 17 provided with individual drives 18, 19. The division of the receiving belts into two belts in each case results in a flexibility which is necessary for the required adaptations to the conveying sequences, as will be shown below. In a simplified embodiment, however, the receiving belts can also each consist of only one belt.

The belt deflections at the inlet of the receiving belts 14 are designed to be displaceable in the vertical direction. For this purpose, the inlets of these conveyor belts are connected in a mechanically articulated manner to a connecting rod 20 and are jointly height-adjustable by means of a servomotor 21, the vertical spacing of the belt deflections corresponding unchanged to the spacing of the discharge belts as a result of the articulated connection.

The vertical distance of the outlet deflection is greater than that at the inlet, so that there is sufficient space for the drives and the products passing underneath. The vertical spacing of these belts thus increases in a radial manner in the conveying direction, so that these belts are arranged at a fixed angle to one another and the end deflections in the outlet of these belts have a fixed vertical spacing from one another.

To allow the inlet deflections of the receiving belts to be adjusted in height, the receiving belts are rotatably articulated at their outlet deflections, specifically in such a way that the pivot points 20 of the individual belts coincide with the centre of the respective end deflections in the outlet of the belt in question.

The receiving belts, which are vertically adjustable on the inlet side, represent a vertical diverter in the counter current direction, a counter current diverter which consists of a plurality of planes and can have a plurality of belts connected one behind the other per plane.

Downstream of the receiving belts 14 are so-called gap closing belts 21. These can be a plurality of belts connected in series per plane, which are necessary for the gap closure. These are usually short belts with which the gaps of the trailing product lines to the leading lines, which gaps are created by the lines being pushed out of the storage onto the discharge belts, can be closed. To close the gaps, the trailing lines are conveyed at a higher speed in the direction of the packaging line, so that the distance to the leading line can be shortened and made up.

In addition, so-called waiting belts can also be arranged on the various levels. These become necessary when the packaging lines have to be charged at different speeds. If, for this purpose, different numbers of product lines per unit of time are allocated to the different planes via the counter current diverter, a free belt having the length of a product line is in each case available with the waiting belts on each plane in order to receive an additional line without delay and to be fed to the relevant packaging line via the gap closing belts connected downstream.

The height-adjustable inlet deflectors 15 of the receiving belts 14 (i.e. the counterflow diverter) provide the greatest possible flexibility with respect to adapting the supply of the packaging lines in the event of delays or failures of individual lines or vice versa in the event of an increased loading requirement.

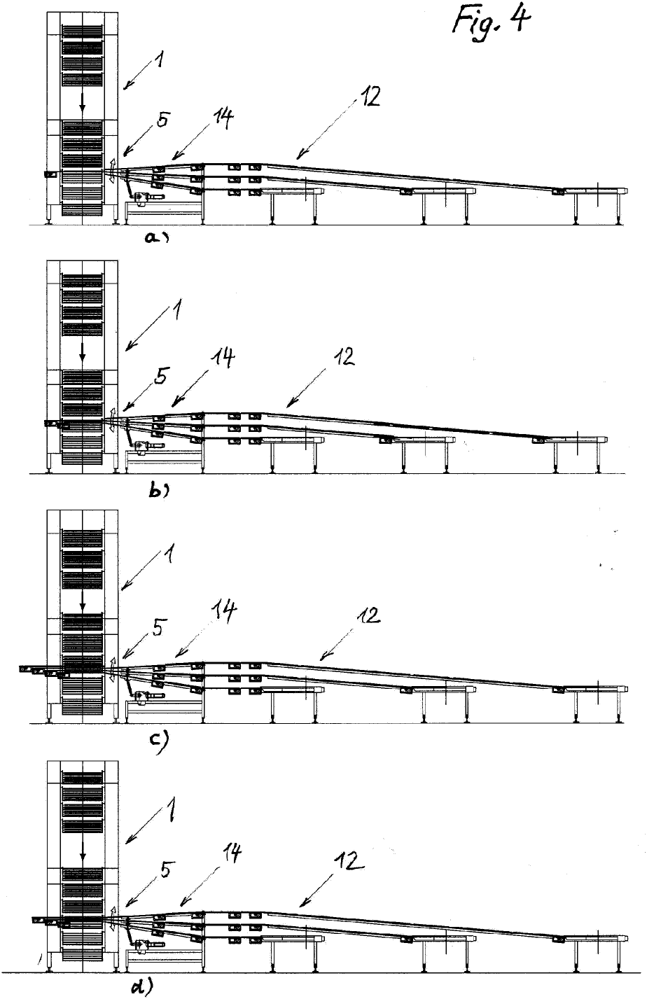

There is also maximum flexibility with regard to the interaction of the counter current diverter with the discharge belts. This is shown by way of example in FIG. 4. FIG. 4a shows a counter current diverter with three planes, the planes of which are fed in succession or in an arbitrarily definable sequence by a single discharge belt. FIG. 4b shows a corresponding arrangement with two discharge belts which feed the three planes of the receiving belts. In the arrangement shown in FIG. 4c, the storage has four discharge belts with which the three planes of the receiving belts are charged. Finally, FIG. 4d shows the already described arrangement with three discharge belts and three receiving belts.

As can be seen from the statements on the interaction of the counterflow diverter with the discharge belts in the preceding paragraph, a counterflow diverter can also comprise only two receiving belts. Due to the height adjustability of the inlet deflectors, a high degree of flexibility is already achieved.

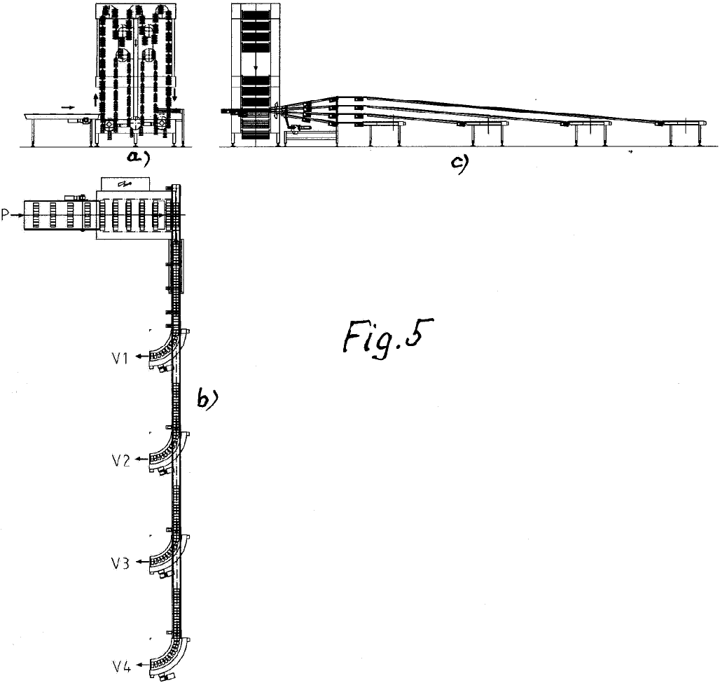

FIG. 5 shows a further embodiment of an overall system with an interim storage 1, product inlet and product outlet, as well as the further lateral conveying sections from the discharge belts 10 to four packaging lines V1-V4. FIG. 5a corresponds to FIG. 1. FIG. 5b is a top view of the installation and shows the course of four further conveying sections 12 to the packaging lines. FIG. 5c is a front view of the system and shows the discharge belts with their drives and a side view of the further conveying sections arranged downstream of the discharge belts.

The advantages of the invention result from the fact that the outlet of the storage is decoupled even further from the packaging lines by the counter current diverter. The packaging lines can start and stop chaotically without this having a negative effect on the push-out of the product series from the storage. The packaging lines can be supplied with product lines independently of one another. Efficiency remains at a high level.

If a packaging line is loaded with product from a storage, then this has the best efficiency, because product is always available from a stock. With the proposed solution, significantly more packaging lines can now be supplied with product from a storage than hitherto. Three, four or more packaging lines can be supplied with product lines from a storage outlet.

In addition, the packaging lines can be operated independently of one another and also at different speeds and can correspondingly be operated with product.

The foregoing has also outlined features of several embodiments so that those skilled in the art can better understand the present disclosure. Those skilled in the art should appreciate that they can readily use the present disclosure as a basis for designing or modifying other methods or devices for carrying out the same purposes and/or achieving the same advantages of the embodiments disclosed herein. Those skilled in the art should also realize that such equivalent constructions do not depart from the spirit and scope of the present disclosure, and that they can make various changes, substitutions, and alterations herein without departing from the spirit and scope of the present disclosure, and the scope thereof is determined by the claims that follow.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A storage outlet for products, wherein;
an interim storage with product carriers disposed on a plurality of levels in the lateral direction; and
one or more discharge belts are arranged one above the other, wherein the one or more discharge belts receive product lines from the interim storage and transfer them to a plurality of downstream receiving belts, wherein the plurality of downstream receiving belts are arranged one above the other and whose inlet deflectors are jointly height-adjustable.

2. The storage outlet according to claim 1, wherein the downstream receiving belts has a bearing or pivot point located at their outlet-side end, wherein the center of the bearing or pivot points are aligned with the center of the outlet-side end deflections.

3. The storage outlet according to claim 1, wherein each downstream receiving belt can be pivoted vertically and comprises one or more downstream receiving belts arranged one behind the other.

4. The storage outlet according to claim 3, wherein the number of vertically pivotable downstream receiving belts arranged one behind the other is greater than two.

5. The storage outlet according to claim 1, wherein the length of the downstream receiving belts corresponds to the length of the product lines.

6. The storage outlet according to claim 1, wherein the number of discharge belts in the outlet of the interim storage depends only on a discharge capacity and is independent of the number of downstream receiving belts.

7. The storage outlet according to claim 1, wherein the number of downstream receiving belts is identical to a number of packaging lines to be loaded.
